(19) United States
(12) Patent Application Publication
(10) Pub. No.: US 2017/0150343 A1
(43) Pub. Date: May 25, 2017

(54) METHOD AND APPARATUS FOR MOBILITY MANAGEMENT

(71) Applicant: NEC Corporation, Tokyo (JP)

(72) Inventor: Takanori IWAI, Tokyo (JP)

(73) Assignee: NEC Corporation, Tokyo (JP)

(21) Appl. No.: 15/323,938

(22) PCT Filed: May 13, 2015
(86) PCT No.: PCT/JP2015/002419

§ 371 Date: Jan. 4, 2017

(30) Foreign Application Priority Data
Jul. 14, 2014 (JP) 2014-144079

(51) Int. Cl. H04W 8/10; H04W 4/00; H04L 29/12; H04W 68/12

(52) U.S. Cl. CPC H04W 8/10; H04W 68/12; H04W 4/005; H04L 61/1588; H04W 84/042

(57) ABSTRACT

A first entity (123) in a core network (111) receives a first message (S101) indicating a mobility characteristic of a Machine Type Communication (MTC) device (111) from an MTC service platform (130) that provides an application programming interface (API) for an MTC application server (132). A second entity (121 or 122) in the core network (111) updates, based on the mobility characteristics received from the MTC service platform (131), at least one of the length of a periodic location update timer and the size of a paging area which are separately applied to the MTC device (111).

### TECHNICAL FIELD

The present disclosure relates to a mobile communication network and more particularly to mobility management of a Machine Type Communication (MTC) device.

### BACKGROUND ART

The Third Generation Partnership Project (3GPP) has examined the standardization of Machine Type Communication (MTC). The MTC is also referred to as a Machine-to-Machine (M2M) network or a sensor network. The 3GPP defines mobile station (MSs), Mobile Terminals (MTs), or User Equipments (UEs) implemented in machines and sensors for the MTC as “MTC devices”. The MTC devices are typically implemented in various types of equipment including machines (e.g., vending machines, gas meters, electric meters, vehicles, railway vehicles) and sensors (e.g., environmental, agricultural, or traffic sensors). The MTC devices are connected to a Public Land Mobile Network (PLMN) and communicate with an MTC application server (AS). The MTC application server is arranged outside the PLMN (external network), executes an MTC application, and communicates with MTC UE applications implemented in the MTC devices. The MTC application server is typically controlled by an MTC service provider (M2M service provider).

The 3GPP specifies network elements including a Service Capability Server (SCS) and a Machine Type Communication Inter Working Function (MTC-IWF), reference points, and procedures to allow the MTC application server to communicate with the MTC devices (see Non-Patent Literature 1). The reference points are also referred to as “interfaces”.

The SCS is an entity to connect the MTC application server to the 3GPP PLMN and to allow the MTC application server to communicate with a UE (i.e., MTC device) through a PLMN service defined by the 3GPP. Further, the SCS allows the MTC application server to communicate with the MTC-IWF. That is, the SCS provides the MTC application server with an application programming interface (API) to allow the MTC application server to use services or capabilities provided by the 3GPP PLMN. It is assumed that the SCS is controlled by a PLMN operator or an MTC service provider. The framework for intermediation including one or more SCSs is, for example, referred to as an “M2M service platform” or an “MTC service platform”. Further in an Open Mobile Alliance (OMA), this framework, which provides the API for the MTC application server, is referred to as an “exposure layer”.

The MTC-IWF is a control plane entity that belongs to the PLMN. The MTC-IWF has a signaling interface (reference point) with the M2M service platform including the SCS, and also has signaling interfaces (reference points) with nodes in the PLMN (e.g., a Home Subscriber Server (HSS), a Short Message Service-Service Center (SMS-SC), a Serving GPRS Support Node (SGSN), a Mobility Management Entity (MME), a Mobile Switching Center (MSC)). The MTC-IWF serves as a control plane interface to allow the MTC application server or the M2M service platform to cooperate (interwork) with the 3GPP PLMN while hiding the details of the topology of the 3GPP PLMN. The MTC application server or the M2M service platform communicates with each MTC devices via the 3GPP PLMN. The MTC application server or the M2M service platform may communicate with each MTC device on a user plane or using a device trigger.

### CITATION LIST

### Non-Patent Literature

[Non-Patent Literature 1] 3GPP TS 23.682 V11.5.0 (2013-09) “3rd Generation Partnership Project; Technical Specification Group Services and System Aspects; Architecture enhancements to facilitate communications with packet data networks and applications (Release 11)”, September, 2013

### SUMMARY OF INVENTION

### Technical Problem

The inventor has studied various use cases of the MTC application. For example, it is expected that the mobility level of an MTC device varies depending on its operation mode, usage state, or usage environment. In the case that an MTC device is mounted on a vehicle, its mobility level varies depending on whether the vehicle is travelling or is stopped. Further, the mobility level of the MTC device may be estimated depending on whether the engine of the vehicle has been started. Further, when an MTC device is a wearable device (e.g., a smart watch or a wrist band device), the mobility level of the MTC device is changed depending on whether a person who is wearing the wearable device is away from home or at home.

It should be noted that the operation mode, usage state, or usage environment of the MTC device can be known by the MTC application server or the M2M service platform (e.g., the SCS) more easily than by the PLMN. This is because the MTC application server or the M2M service platform is able to freely communicate with the MTC device via the PLMN on the user plane (i.e., on an application layer). Alternatively, the MTC application server or the M2M service platform may be able to know the usage state or usage environment of the MTC device via another communication means implemented in the machine or sensor on which the MTC device is mounted. Further alternatively, the MTC application server or the M2M service platform may be able to know the operation mode, usage state, or usage environment of the MTC device based on warning information regarding weather or oceans announced by government or non-government organizations.

Accordingly, in order to optimize the mobility management of an MTC device in the PLMN in accordance with the mobility characteristics of the MTC device, it may be preferable to use the mobility characteristics of the MTC device obtained in the MTC application server or the M2M service platform. However, Non-Patent Literature 1 does not teach such a control operation or a control procedure.

Accordingly, one object to be attained by embodiments disclosed herein is to provide a method, an apparatus, and a program that contribute to mobility management of an MTC device in a PLMN using mobility characteristics of the MTC device obtained in an MTC application server or an M2M service platform. The other objects or problems and novel features will be made apparent from the following descriptions and the accompanying drawings.

### Solution to Problem

In a first aspect, a mobility management method of an MTC device includes: (A) receiving, by a first entity in a core network, a first message indicating a mobility characteristic of the MTC device from an MTC service platform that provides an MTC application server with an application programming interface (API) to allow the MTC application server to use a service served by a mobile communication network including the core network and a radio access network; and (B) updating, by a second entity in the core network, based on the mobility characteristic, at least one of the length of a periodic location update timer and the size of a paging area which are separately applied to the MTC device.

In a second aspect, a method, performed by a service capability entity that provides an application programming interface (API) for an MTC application server, includes sending a first message indicating a mobility characteristic of an MTC device to a network entity in a core network. The first message causes the core network to update at least one of the length of a periodic location update timer and the size of a paging area which are separately applied to the MTC device.

In a third aspect, a subscriber server, arranged in a core network, includes a memory configured to store subscriber information of an MTC device, and a processor coupled to the memory and configured to perform a control procedure for assisting mobility management of the MTC device. The control procedure includes (A) receiving a mobility characteristic of the MTC device from an MTC service platform via a network entity in the core network and (B) updating, based on the mobility characteristic, the length of a periodic location update timer separately applied to the MTC device.

In a fourth aspect, a mobility management entity, arranged in a core network, includes a memory and a processor coupled to the memory and configured to perform mobility management of an MTC device. The mobility management includes (A) receiving a mobility characteristic of the MTC device from an MTC service platform via a network entity in the core network and (B) updating, based on the mobility characteristic, the size of a paging area separately applied to the MTC device.

In a fifth aspect, a service capability entity, configured to provide an application programming interface (API) for an MTC application server, includes a memory and a processor coupled to the memory and configured to execute the method according to the aforementioned second aspect.

In a sixth aspect, a program includes instructions (software codes) that, when loaded into a computer, causes the computer to execute a control procedure performed by a subscriber server arranged in a core network. The control procedure includes (A) receiving a mobility characteristic of an MTC device from an MTC service platform via a network entity in the core network and (B) updating, based on the mobility characteristic, the length of a periodic location update timer separately applied to the MTC device.

In a seventh aspect, a program includes instructions (software codes) that, when loaded into a computer, causes the computer to execute a control procedure performed by a mobility management entity arranged in a core network. The control procedure includes (A) receiving a mobility characteristic of an MTC device from an MTC service platform via a network entity in the core network and (B) updating, based on the mobility characteristic, the size of a paging area separately applied to the MTC device.

In an eighth aspect, a program includes instructions (software codes) that, when loaded into a computer, causes the computer to execute the method according to the aforementioned second aspect.

### Advantageous Effects of Invention

According to the aforementioned aspects, it is possible to provide a method, an apparatus, and a program that contribute to the mobility management of an MTC device in a PLMN using mobility characteristics of the MTC device obtained in an MTC application server or an M2M service platform.

### BRIEF DESCRIPTION OF DRAWINGS

FIG. 1 is a diagram showing a configuration example of a mobile communication network according to an embodiment of the present invention;

FIG. 2 is a sequence diagram showing a specific example of a procedure for updating a periodic location update timer according to an embodiment of the present invention;

FIG. 3 is a sequence diagram showing a specific example of a procedure for updating a paging area according to an embodiment of the present invention;

FIG. 4 is a sequence diagram showing a specific example of a procedure for updating a paging area according to an embodiment of the present invention;

FIG. 5 is a block diagram showing a configuration example of an MME according to an embodiment of the present invention;

FIG. 6 is a block diagram showing a configuration example of an HSS/HLR according to an embodiment of the present invention; and

FIG. 7 is a block diagram showing a configuration example of an SCS according to an embodiment of the present invention.

### DESCRIPTION OF EMBODIMENTS

Specific embodiments will be described hereinafter in detail with reference to the drawings. Throughout the drawings, the same or corresponding elements are denoted by the same reference symbols, and repetitive explanations will be omitted as appropriate for the sake of clarity.

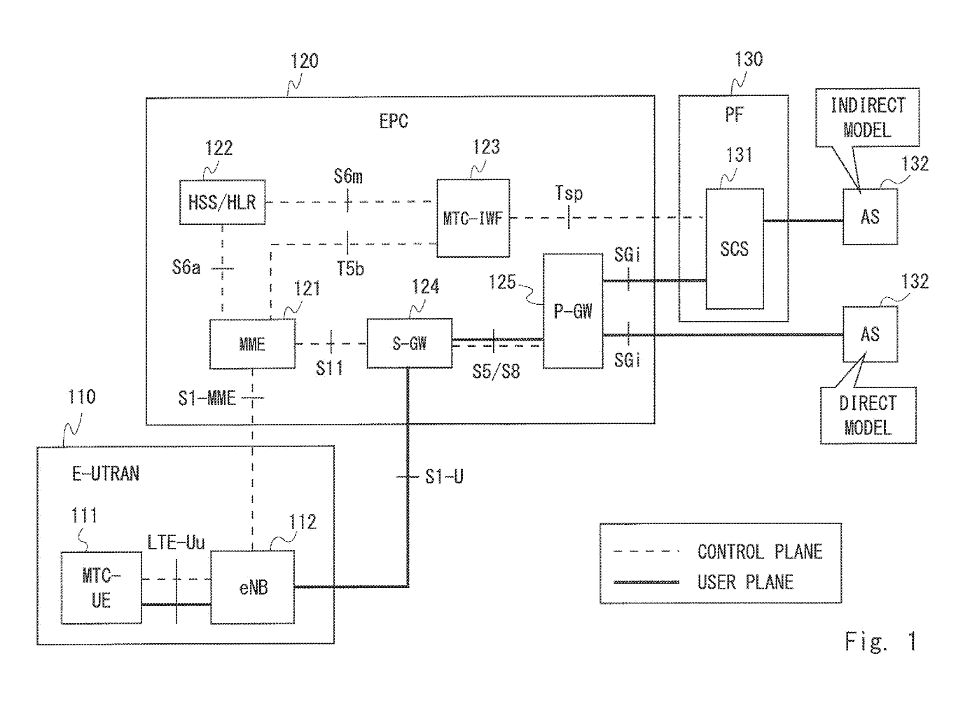

FIG. 1 shows a configuration example of a mobile communication network, i.e., a PLMN, according to an embodiment of the present invention. The mobile communication network provides communication services, such as voice communication or packet data communication or both, for example. In this embodiment, it is assumed that the mobile communication network is an Evolved Packet System (EPS). The EPS may also be referred to as a Long Term Evolution (LTE) system or an LTE-Advanced system. However, this embodiment can also be applied to other radio communication systems such as a Universal Mobile Telecommunications System (UMTS).

The network shown in FIG. 1 includes an E-UTRAN 110, an EPC 120, and an M2M service platform 130. The E-UTRAN 110 includes an MTC device (MTC UE) 111 and an eNodeB 112. The EPC 120 includes an MME 121, an HSS/Home Location Register (HLR) 122, an MTC-IWF 123, a Serving Gateway (S-GW) 124, and a Packet Data Network Gateway (P-GW) 125. The M2M service platform 130 includes an SCS 131. As already stated above, the M2M service platform 130 can also be referred to as an MTC service platform or an exposure layer.

First, entities in the E-UTRAN 110 will be described. The MTC UE 111 executes an MTC UE application and serves as an MTC device. The MTC UE 111, which serves as the MTC device, establishes a signaling connection (i.e., a Non-Access Stratum (NAS) connection) with the MME 121 via the E-UTRAN 110 and communicates with an MTC application server 132 via the S-GW 124 and the P-GW 125 on the user plane.

The MTC UE 111 may be an MTC gateway device. The MTC gateway device has a 3GPP mobile communication function (i.e., a function of a UE) and is connected to a neighboring device (e.g., a sensor, a radio frequency identification (RFID) tag, or a car navigation device) by a personal/local area connection technology. Specific examples of the personal/local area connection technology include IEEE 802.15, ZigBee (registered trademark), Bluetooth (registered trademark), and IEEE 802.11a. The neighboring device connected to the MTC gateway device is typically a device that does not have the 3GPP mobile communication function, but may be a device that has the 3GPP mobile communication function (i.e., an MTC device). In this description, the term “MTC device” and the term “MTC gateway device” are not particularly distinguished from each other. That is, the term “MTC device” used in this description includes the MTC gateway device.

The eNodeB 112 establishes a Radio Resource Control (RRC) connection with the MTC UE 111 and configures a signaling radio bearer (SRB) with the MTC UE 111. Via the SRB, the eNodeB 112 provides RRC signaling to configure and modify a data radio bearer (DRB) and also provides NAS message transfer between the EPC 120 (i.e., the MME 121) and the MTC UE 111, for example. NAS messages are not terminated at the E-UTRAN 110 and are transparently transmitted between the MTC UE 111 and the MME 121. Further, the eNodeB 112 sends and receives user data of the MTC UE 111 via the DRB with the MTC UE 111.

Next, entities in the EPC 120 will be described. The MME 121, the HSS/HLR 122, and the MTC-IWF 123 are control-plane nodes or entities. The MME 121 performs mobility management and bearer management of a plurality of UEs including the MTC UE 111, which have attached to the EPC 120 (i.e., in EMM-REGISTERED state). The mobility management is used to keep track of the current location of each UE and includes maintaining a mobility management context (MM context) regarding each UE. The bearer management includes controlling establishment of an EPS bearer to allow each UE to communicate with an external network (Packet Data Network (PDN)) via the E-UTRAN 110 and the EPC 120 and maintaining an EPS bearer context regarding each UE.

The HSS/HLR 122 manages subscriber information of UEs including the MTC UE 111. Further, the HSS/HLR 122 records information about the MME (e.g., MME Identity) that manages each of the UEs having attached to the EPC 120 (i.e., UEs in EMM-REGISTERED state).

The MTC-IWF 123 is a control plane entity that belongs to the EPC 120. The MTC-IWF 123 communicates with other network entities including the MME 121 and the HSS/HLR 122 via signaling interfaces (reference points). As already stated above, the MTC-IWF 123 serves as a control plane interface or gateway to allow the MTC application server 132 or the M2M service platform 130 to cooperate (interwork) with the 3GPP PLMN while hiding the details of the topology of the 3GPP PLMN.

The MTC-IWF 123 communicates with the SCS 131 via a Tsp reference point. The SCS 131 connects the MTC application server 132 to the PLMN including the E-UTRAN 110 and the EPC 120 and thereby allows the MTC application server 132 to communicate with the MTC UE 111 (that is, the MTC device) via PLMN services defined by the 3GPP. The Tsp reference point may be used, for example, to send a device trigger transmission request (Device Trigger Request (DTR)) from the SCS 131 to the MTC-IWF 123 and to report a device trigger result from the MTC-IWF 123 to the SCS 131.

The MTC-IWF 123 communicates with the HSS/HLR 122 via an S6m reference point. The S6m reference point may be used, for example, to send an inquiry about subscriber information from the MTC-IWF 123 to the HSS/HLR 122 and to send the subscriber information from the HSS/HLR 122 to the MTC-IWF 123.

The MTC-IWF 123 communicates with the MME 121 via a T5b reference point. The T5b reference point may be used, for example, to send a device trigger request from the MTC-IWF 123 to the MME 121 and to report a success or failure of the device trigger from the MME 121 to the MTC-IWF 123.

The S-GW 124 is a user plane packet forwarding node arranged in the EPC 120 and forwards user data packets of the MTC UE 111. The S-GW 124 serves as a gateway to the E-UTRAN 110. The S-GW 124 has a user plane tunneling interface (i.e., an S1-U reference point) to the E-UTRAN 110 and a user plane tunneling interface (i.e., an S5/S8 reference point) to the P-GW 125. The S-GW 124 also has a signaling interface (i.e., an S11 reference point) to the MME 121.

The P-GW 125, as well as the S-GW 124, is a user plane packet forwarding node arranged in the EPC 120 and forwards user data packets of the MTC UE 111. The P-GW 125 serves as a gateway to a PDN outside the 3GPP PLMN and provides connectivity with the PDN for the MTC UE 111. In the example shown in FIG. 1, the PDN includes the SCS 131 and the application server 132.

Next, entities arranged outside the PLMN (the E-UTRAN 110 and the EPC 120) will be described. The M2M service platform 130, which includes the SCS 131, and the MTC application server 132 communicate with the MTC UE 111 via the E-UTRAN 110 and the EPC 120.

The SCS 131 provides the MTC application server 132 with one or more APIs to allow the MTC application server 132 to communicate with the MTC-IWF 123. The SCS 131 is controlled by a PLMN operator or an MTC service provider. The SCS 131 is also referred to as an MTC server, an M2M server, or an API Gateway Function (API-GWF). The SCS 131 may communicate with the MTC UE 111 on the user plane or using a device trigger. The SCS 131 may be a single independent physical entity or may be a functional entity added to another network element (e.g., the MTC-IWF 123 or the MTC application server 132).

The MTC application server 132 executes an MTC application and communicates with the MTC UE application implemented in the MTC UE 111. The MTC application server 132 is also referred to as an M2M application server.

Further, in this embodiment, the mobile communication network (PLMN) including the E-UTRAN 110 and the EPC 120 receives, from the M2M service platform 130, device information indicating behavior or characteristics of the MTC UE 111. Here, the device information regarding the MTC UE 111 indicates mobility characteristics of the MTC UE 111. The PLMN including the E-UTRAN 110 and the EPC 120 updates, based on the device information on the MTC UE 111 sent from the M2M service platform 130, at least one of (a) the length of a periodic location update timer (i.e., a periodic Tracking Area Update (TAU) timer) separately applied to the MTC UE 111 and (b) the size of a paging area separately applied to the MTC UE 111.

The periodic TAU timer defines the interval of the periodic location update (i.e., TAU) performed by the MTC UE 111. The periodic TAU timer is referred to as a T3412 timer. The MME 121 sends a value of the periodic TAU timer to the MTC UE 111 using a NAS message (specifically, an ATTACH ACCEPT message or a TAU ACCEPT message). The MTC UE 111 uses the timer value received from the MME 121 and executes the periodic TAU.

The paging area is determined by the MME 121 and defines a range in which a paging message sent from the MME 121 to page the MTC UE 111 is transmitted by radio. The paging area is typically determined based on a location registration area (i.e., a tracking area (TA)) of the MTC UE 111 obtained in the MME 121 and includes a plurality of cells and a plurality of base stations (eNodeBs).

Specifically, the M2M service platform 130 (e.g., the SCS 131) may send the device information regarding the MTC UE 111 to the MTC-IWF 123. The MTC-IWF 123 may send the received device information to the MME 121 or the HSS/HLR 122 or both. The device information sent to the MME 121 and/or the HSS/HLR 122 via the MTC-IWF 123 is used to determine one or both of the periodic TAU timer value and paging area size for the MTC UE 111.

When the device information sent from the M2M service platform 130 (e.g., the SCS 131) indicates that the mobility level of the MTC UE 111 is large, the EPC 120 including the MME 121 and the HSS/HLR 122 may reduce the value of the periodic TAU timer separately applied to the MTC UE 111. In other words, the EPC 120 may reduce the periodic TAU timer value for the MTC UE 111 as the mobility level of the MTC UE 111 increases. Accordingly, the EPC 120 can accurately know the current location of the MTC UE 111 in the idle state (ECM IDLE state). Otherwise, the EPC 120 may increase the periodic TAU timer value for the MTC UE 111 as the mobility level of the MTC UE 111 decreases. Accordingly, the EPC 120 can reduce the signaling load due to frequent TAU.

Further or alternatively, when the device information sent from the M2M service platform 130 (e.g., the SCS 131) indicates that the mobility level of the MTC UE 111 is large, the EPC 120 may increase the size of the paging area separately applied to the MTC UE 111. In other words, the EPC 120 may increase the paging area size for the MTC UE 111 as the mobility level of the MTC UE 111 increases. Accordingly, the EPC 120 can reduce paging failures. Otherwise, the EPC 120 may decrease the paging area size for the MTC UE 111 as the mobility level of the MTC UE 111 decreases. Accordingly, the E-UTRAN 110 and the EPC 120 can reduce the paging load due to paging of the MTC UE 111 in a large number of cells.

In the following description, some specific examples of the device information regarding the MTC UE 111 sent from the M2M service platform 130 (e.g., the SCS 131) to the MTC-IWF 123 will be described. As already stated above, the device information indicates mobility characteristics of the MTC UE 111. For example, the mobility characteristics of the MTC UE 111 may indicate the mobility level of the MTC UE 111.

One example of the M2M services is an Intelligent Transport Systems (ITS) service. When the MTC UE 111 is a device disposed in a vehicle, the mobility characteristics indicated by the device information may indicate whether the vehicle is travelling or whether an engine of the vehicle has been started. It can be estimated that the mobility of the MTC UE 111 is greater when the vehicle is travelling than when the vehicle is not travelling. Further, it can be estimated that the mobility of the MTC UE 111 is greater when the engine of the vehicle has been started than when the engine is not started.

Another example of the M2M services is tracking the location of freight in logistics services. When the MTC UE 111 is a device attached to the freight, the mobility characteristics indicated by the device information may indicate whether the freight is being transported or is located in a delivery center. It can be estimated that the mobility of the MTC UE 111 is greater when the freight is being transported than when the freight is located in the delivery center.

Another example of the M2M services is a healthcare service or home security service using a wearable device. When the MTC UE 111 is a wearable device, the mobility characteristics indicated by the device information may indicate whether a person who is wearing the

MTC UE 111 is away from home or at home. It can be estimated that the mobility of the MTC UE 111 is greater when the person is away from home than when the person is at home.

Another example of the M2M services is a pet monitoring service. When the MTC UE 111 is a device that is attached to an animal and is used to monitor the animal, the mobility characteristics indicated by the device information may indicate whether this animal is away from home or at home. It can be estimated that the mobility of the MTC UE 111 is greater when the animal is away from home than when the animal is at home.

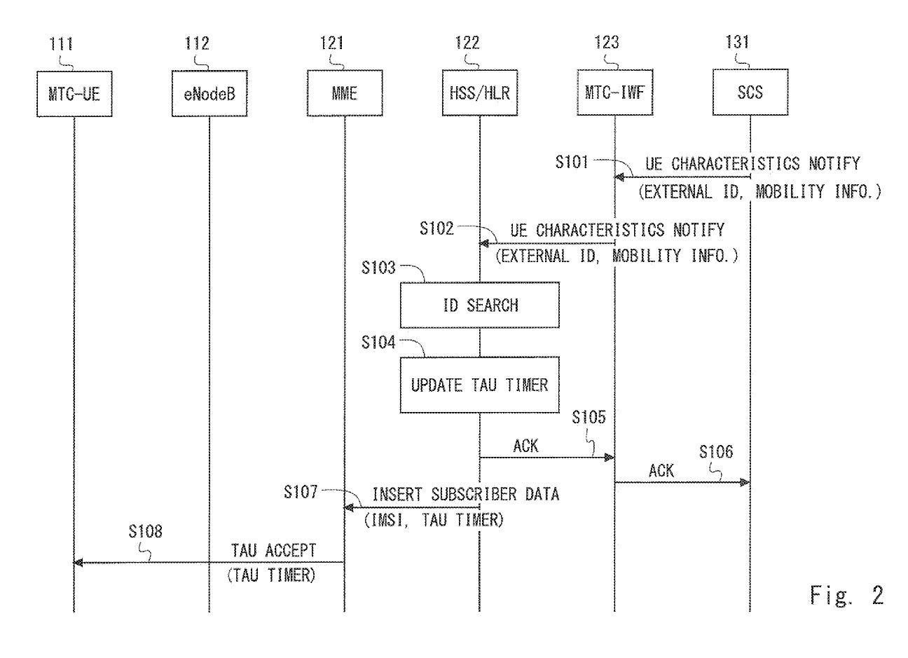

In the following description, a specific example of a procedure for updating the periodic TAU timer value and the paging area size will be described. FIG. 2 shows a specific example of the procedure for updating the value of the periodic TAU timer. In Step S101, the SCS 131 sends a UE CHARACTERISTICS NOTIFY message to the MTC-IWF 123. The SCS 131 may send the UE CHARACTERISTICS NOTIFY message in response to detecting a change in the UE characteristics (specifically, the mobility characteristics) of the MTC UE 111.

The UE CHARACTERISTICS NOTIFY message indicates an external identifier (External ID) of the MTC UE 111 and mobility information on the MTC UE 111. The external identifier is used to identify the MTC UE 111 in the M2M service platform 130 or in the MTC application server 132. The external identifier may be, for example, a Mobile Subscriber Integrated Services Digital Network Number (MSISDN). The mobility information on the MTC UE 111 indicates the mobility characteristics of the MTC UE 111.

In Step S 102, the MTC-IWF 123 forwards the UE CHARACTERISTICS NOTIFY message to the HSS/HLR 122. In Step 5103, the HSS/HLR 122 receives the UE CHARACTERISTICS NOTIFY message and searches for an internal identifier (Internal ID) of the MTC UE 111 based on the external identifier of the MTC UE 111. The internal identifier may be, for example, an International Mobile Subscriber Identity (IMSI).

In Step S104, the periodic TAU timer value for the MTC UE 111 stored in association with the internal identifier (e.g., the IMSI) of the MTC UE 111 is updated. The periodic TAU timer value may be stored in the HSS/HLR 122 as a part of the subscriber information of the MTC UE 111. In Step S105, the HSS/HLR 122 sends a response message (ACK message) to the MTC-IWF 123. In Step S106, the MTC-IWF 123 sends a response message (ACK message) to the SCS 131.

In Step S107, the HSS/HLR 122 notifies the MME 121 of the updating of the periodic TAU timer value separately applied to the MTC UE 111. For notifying the MME 121 of the updated periodic TAU timer value, the HSS/HLR 122 may use a Diameter message that is sent on the S6a interface between the MME 121 and the HSS/HLR 122. As shown in FIG. 2, an INSERT SUBSCRIBER DATA message may be used. The INSERT SUBSCRIBER DATA message is used by the HSS/HLR 122 to autonomously notify the MME 121 of the subscriber information. The SUBSCRIBER DATA message indicates the internal identifier (the MSISDN) and subscriber information (in this example, the updated periodic TAU timer value) of the MTC UE 111.

In Step S108, the MME 121 notifies the MTC UE 111 of the updated periodic TAU timer value. The MME 121 uses a NAS message to notify the MTC UE 111 of the updated periodic TAU timer value. As shown in FIG. 2, the MME 121 may send a TAU ACCEPT message indicating the updated periodic TAU timer value to the MTC UE 111 during a TAU procedure performed after being notified about the updated periodic TAU timer value from the HSS/HLR 122. The MTC UE 111 performs the periodic TAU using the updated periodic TAU timer value sent from the MME 121.

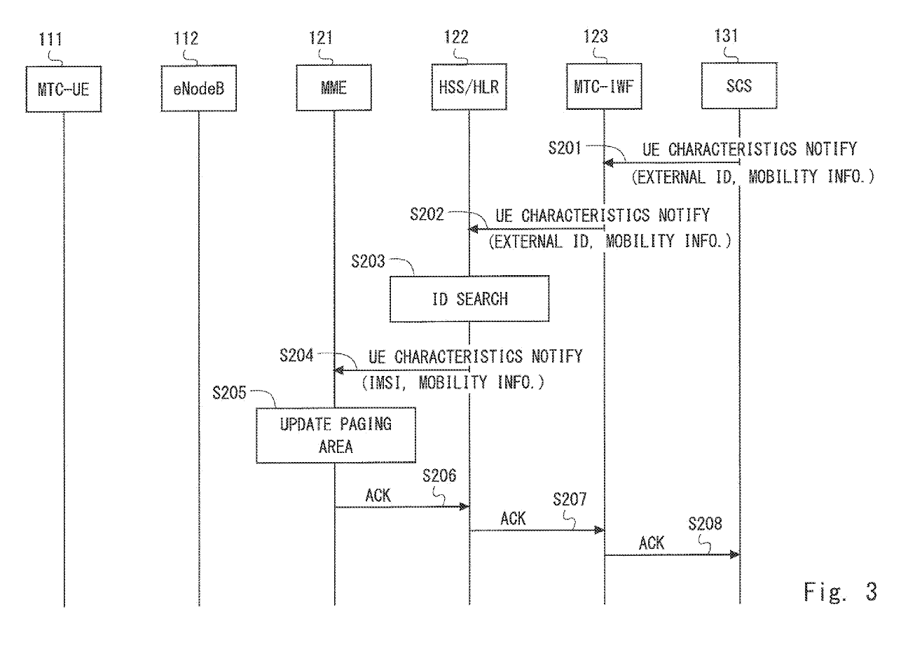

FIG. 3 shows a specific example of the procedure for updating the paging area size. The processes in Steps S201-S203 are the same as the processes in Steps S101-S103 in FIG. 2.

In Step S204, the HSS/HLR 122 sends a UE CHARACTERISTICS NOTIFY message to the MME 121 that is performing the mobility management of the MTC UE 111. The UE CHARACTERISTICS NOTIFY message sent in Step S204 includes the internal identifier (e.g., the IMSI) to specify the MTC UE 111. In Step S205, the MME 121 updates the paging area size for the MTC UE 111 that is stored in association with the internal identifier (e.g., the IMSI) of the MTC UE 111. The MME 121 may hold the paging area size as a part of the MM context of the MTC UE 111. When paging the MTC UE 111, the MME 121 determines the paging area in accordance with the updated paging area size.

In Step S206, the MME 121 sends a response message (ACK message) to the HSS/HLR 122. In Step S207, the HSS/HLR 122 sends a response message (ACK message) to the MTC-IWF 123. In Step S208, the MTC-IWF 123 sends a response message (ACK message) to the SCS 131.

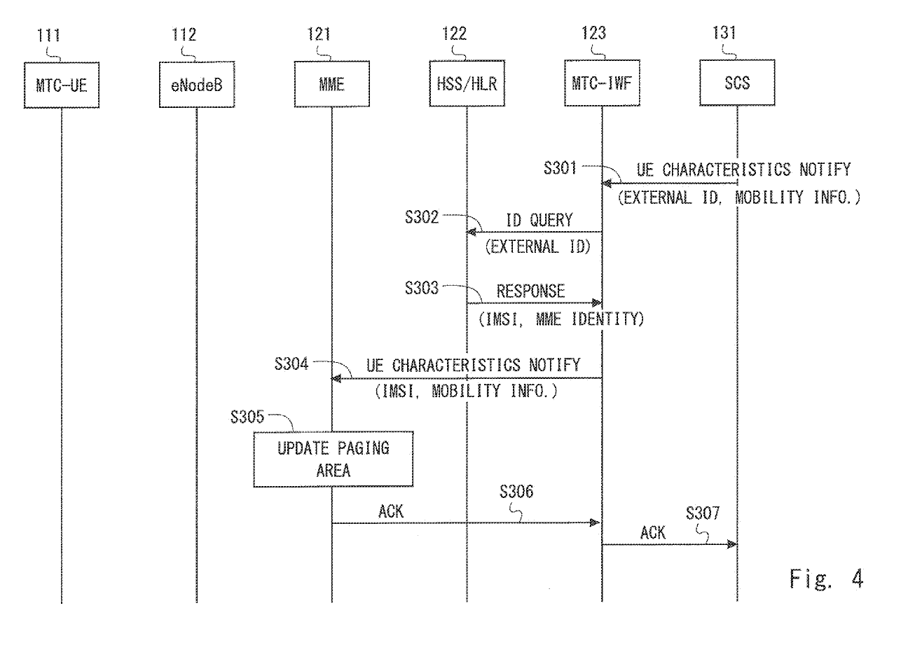

FIG. 4 shows another specific example of the procedure for updating the paging area size. In the aforementioned example shown in FIG. 3, the MME 121 receives the UE CHARACTERISTICS NOTIFY message indicating the mobility characteristics of the MTC UE 111 from the HSS/HLR 122 via the S6a reference point. On the other hand, in the example shown in FIG. 4, the MME 121 receives the UE CHARACTERISTICS NOTIFY message indicating the mobility characteristics of the MTC UE 111 from the MTC-IWF 123 via the T5b reference point.

The process performed in Step S301 in FIG. 4 is the same as the processes performed in Step S101 in FIG. 2 and Step S201 in FIG. 3. In Step S302, in order to acquire the internal identifier (e.g., the IMSI) of the MTC UE 111, the MTC-IWF 123 sends to the HSS/HLR 122 an inquiry about the internal identifier corresponding to the external identifier (e.g., the MSISDN) of the MTC UE 111. Specifically, the MTC-IWF 123 may request the HSS/HLR 122 to send the subscriber information corresponding to the external identifier of the MTC UE 111. In Step S303, the HSS/HLR 122 searches for the internal identifier of the MTC UE 111 based on the external identifier of the MTC UE 111. The HSS/HLR 122 then sends to the MTC-IWF 123 a response message indicating the internal identifier (e.g., the IMSI) of the MTC UE 111 and the identifier (MME Identity) of the MME that is performing the mobility management of the MTC UE 111. The MME Identity may be, for example, a Globally Unique MME Identity (GUMMEI), or an IP address of the MME, or both of them. If the MTC-IWF 123 has already known the internal identifier of the MTC UE 111, Steps S302 and S303 may be omitted.

In Step S304, the MTC-IWF 123 sends the UE CHARACTERISTICS NOTIFY message to the MME 121 that is performing the mobility management of the MTC UE 111. The UE CHARACTERISTICS NOTIFY message sent in Step S304 includes the internal identifier (e.g., the IMSI) to specify the MTC UE 111.

The process performed in Step S305 is the same as the process performed in Step S205 in FIG. 3. In Step S306, the MME 121 sends a response message (ACK message) to the MTC-IWF 123. In Step S307, the MTC-IWF 123 sends a response message (ACK message) to the SCS 131.

As will be understood from the aforementioned descriptions, in this embodiment, the MTC-IWF 123 included in the EPC 120 receives the message (e.g., the UE CHARACTERISTICS NOTIFY message) indicating the mobility characteristics of the MTC UE 111 from the entity (e.g., the SCS 131) included in the M2M service platform 130. Then the MME 121 included in the EPC 120 determines the periodic TAU timer or the paging area size or both of them, which are separately applied to the MTC UE 111, based on the mobility characteristics of the MTC UE 111 sent from the M2M service platform 130. Accordingly, the EPC 120 of this embodiment can use the mobility characteristics of the MTC device (i.e., the MTC UE 111), which is obtained in the M2M service platform 130 or the MTC application server 132, to perform the mobility management of the MTC device (i.e., the MTC UE 111) in the PLMN.

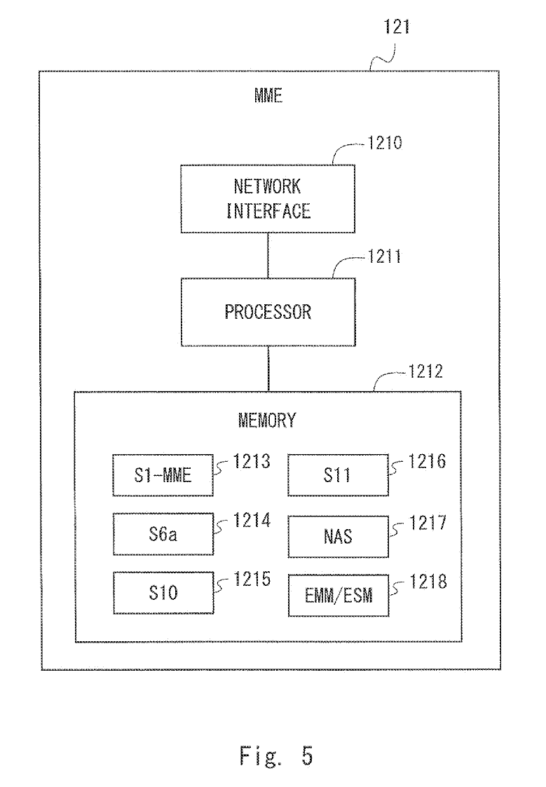

Lastly, configuration examples of the MME 121, the HSS/HLR 122, and the SCS 131 according to the aforementioned embodiment will be described. FIG. 5 shows a configuration example of the MME 121.

Referring to FIG. 5, the MME 121 includes a network interface 1210, a processor 1211, and a memory 1212. The network interface 1210 is used to communicate with other network nodes (e.g., the eNodeB 112, the HSS/HLR 122, the MTC-IWF 123, and the S-GW 124). The network interface 1210 may include, for example, a network interface card (NIC) conforming to the IEEE 802.3 series.

The processor 1211 loads software (computer program) from the memory 1212 and executes the loaded software, thereby performing communication control (e.g., the mobility management and the bearer management). The processor 1211 may be, for example, a microprocessor, a Micro Processing Unit (MPU), or a Central Processing Unit (CPU). The processor 1211 may include a plurality of processors.

The memory 1212 is composed of a combination of a volatile memory and a nonvolatile memory. The volatile memory is, for example, a Static Random Access Memory (SRAM), a Dynamic RAM (DRAM) or a combination thereof. The nonvolatile memory is, for example, a mask Read Only Memory (MROM), a Programmable ROM (PROM), a flash memory, a hard disc drive, or a combination thereof. The memory 1212 may include a storage physically spaced apart from the processor 1211. In this case, the processor 1211 may access the memory 1212 via the network interface 1210 or another I/O interface (not shown).

In the example shown in FIG. 5, the memory 1212 is used to store software modules including an S1-MME module 1213, an S6a module 1214, an S10 module 1215, an S11 module 1216, a NAS module 1217, and an EPS Mobility Management (EMM)/EPS Session Management (ESM) module 1218. The EMM/ESM module 1218 includes instructions and data to perform the procedure for updating the periodic TAU timer value and the paging area size based on the mobility characteristics of the MTC UE 111 sent from the M2M service platform 130, as described in the aforementioned embodiment. The processor 1211 loads the EMM/ESM module 1218 from the memory 1212 and executes the loaded module, thereby performing the operation of the MME 121 regarding the procedure for updating the periodic TAU timer value and the paging area size described in the aforementioned embodiment.

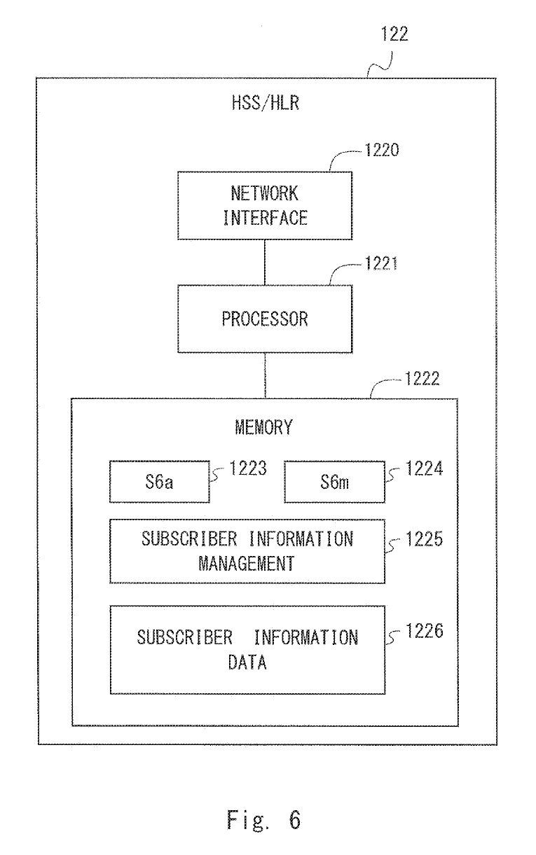

FIG. 6 shows a configuration example of the HSS/HLR 122. Referring to FIG. 6, the HSS/HLR 122 includes a network interface 1220, a processor 1221, and a memory 1222. The network interface 1220 is used to communicate with other network nodes (e.g., the MME 121 and the MTC-IWF 123). The network interface 1220 may include, for example, a network interface card (NIC) conforming to the IEEE 802.3 series.

The processor 1221 loads software (computer program) from the memory 1222 and executes the loaded software, thereby performing communication control including management of the subscriber information. The processor 1221 may be, for example, a microprocessor, an MPU, or a CPU. The processor 1221 may include a plurality of processors.

The memory 1222 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disc drive, or a combination thereof. The memory 1222 may include a storage that is physically spaced apart from the processor 1221. In this case, the processor 1221 may access the memory 1222 via the network interface 1220 or another I/O interface (not shown).

In the example shown in FIG. 6, the memory 1222 is used to store software modules including an S6a module 1223, an S6m module 1224, and a subscriber information management module 1225, and a subscriber information data 1226. The subscriber information management module 1225 includes instructions and data to perform the procedure for updating the periodic TAU timer value and the paging area size based on the mobility characteristics of the MTC UE 111 sent from the M2M service platform 130, as described in the aforementioned embodiment. The processor 1221 loads the subscriber information management module 1225 from the memory 1222 and executes the loaded module, thereby performing the operation of the HSS/HLR 122 regarding the procedure for updating the periodic TAU timer value and the paging area size described in the aforementioned embodiment.

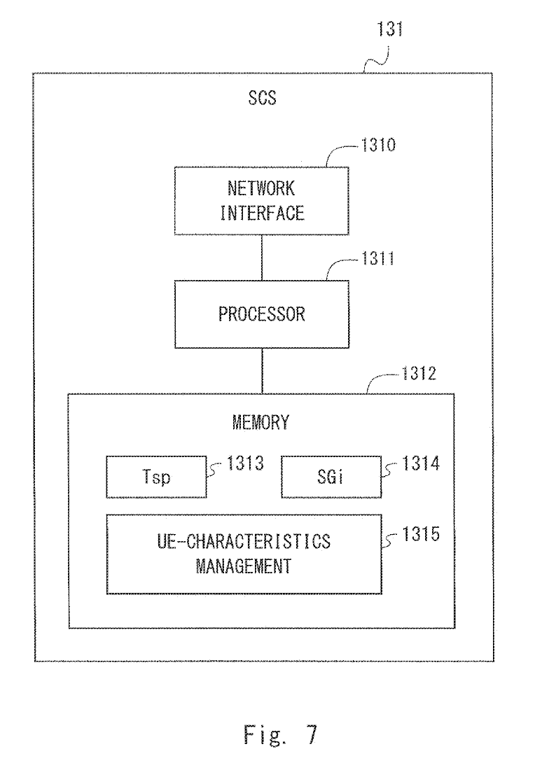

FIG. 7 shows a configuration example of the SCS 131. Referring to FIG. 7, the SCS 131 includes a network interface 1310, a processor 1311, and a memory 1312. The network interface 1310 is used to communicate with other network nodes (e.g., the MTC-IWF 123 and the MTC application server 132). The network interface 1310 may include, for example, a network interface card (NIC) conforming to the IEEE 802.3 series.

The processor 1311 loads software (computer program) from the memory 1312 and executes the loaded software, thereby performing communication control for the MTC device (e.g., device trigger and acquisition of the communication characteristics of the MTC device). The processor 1311 may be, for example, a microprocessor, an MPU, or a CPU. The processor 1311 may include a plurality of processors.

The memory 1312 is composed of a combination of a volatile memory and a nonvolatile memory. The volatile memory is, for example, an SRAM, a DRAM, or a combination thereof. The nonvolatile memory is, for example, an MROM, a PROM, a flash memory, a hard disc drive, or a combination thereof. The memory 1312 may include a storage physically spaced apart from the processor 1311. In this case, the processor 1311 may access the memory 1312 via the network interface 1310 or another I/O interface (not shown).

In the example shown in FIG. 7, the memory 1312 is used to store software modules including a Tsp module 1313, an SGi module 1314, and a UE characteristics management module 1315. The UE characteristics management module 1315 includes instructions and data to perform the procedure for notifying the EPC 120 (i.e., the MTC-IWF 123) of the mobility characteristics of the MTC UE 111 obtained by the M2M service platform 130 or the MTC application server 132, as described in the aforementioned embodiment. The processor 1311 loads the UE characteristics management module 1315 from the memory 1312 and executes the loaded module, thereby performing the operation of the SCS 131 regarding the procedure for updating the periodic TAU timer value and the paging area size described in the aforementioned embodiment.

As described with reference to FIGS. 5-7, the processors included in the MME 121, the HSS/HLR 122, and the SCS 131 according to the aforementioned embodiment each execute one or more programs including instructions that cause a computer to perform the algorithm described with reference to the sequence diagrams or the like.

These programs can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc Read Only Memory (CD-ROM), CD-R, CD-R/W, and semiconductor memories (such as mask ROM, Programmable ROM (PROM), Erasable PROM (EPROM), flash ROM, Random Access Memory (RAM), etc.). These programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### Other Embodiments

The architecture shown in FIG. 1 is merely one example of the architecture for the MTC in the 3GPP. For example, the functions and the entities arranged in the M2M service platform 130 (the MTC service platform, the exposure layer) and the names thereof may be changed in the future releases or versions. The SCS 131 described in the aforementioned embodiment may be called, for example, an API Gateway Function (API-GWF). Alternatively, the functions of the SCS 131 may be divided into an SCS and an API-GWF. The technical ideas described in the aforementioned embodiment can also be applied to these modified architectures for the MTC.

The descriptions have been given in the aforementioned embodiment mainly using the specific examples regarding the EPS. However, the aforementioned embodiment may be applied to other mobile communication systems (e.g., a Universal Mobile Telecommunications System (UMTS), a 3GPP2 CDMA2000 system (1xRTT, High Rate Packet Data (HRPD)), a Global System for Mobile communications (GSM (registered trademark))/General packet radio service (GPRS) system, and a mobile WiMAX system).

Further, the above-described embodiments are merely examples regarding applications of technical ideas obtained by the inventor. Needless to say, these technical ideas are not limited to the above-described embodiments and may be changed in various ways.

This application is based upon and claims the benefit of priority from Japanese Patent Application No. 2014-144079, filed on Jul. 14, 2014, the disclosure of which is incorporated herein in its entirety by reference.

### REFERENCE SIGNS LIST

110 Evolved Universal Terrestrial Radio Access Network (E-UTRAN)
111 User Equipment (UE)
112 eNodeB
120 Evolved Packet Core (EPC)
121 Mobility Management Entity (MME)
122 Home Subscriber Server (HSS)
123 Machine Type Communication Inter Working Function (MTC-IWF)
124 Serving Gateway (S-GW)
125 Packet Data Network Gateway (P-GW)
130 Machine-to-Machine (M2M) service platform
131 Service Capability Server (SCS)
132 MTC Application Server (AS)

1. A core network node arranged in a core network, the core network node comprising:
a memory that stores the instructions; and
a processor coupled to the memory and configured to execute the instructions to:
receive, a mobility characteristic of a Machine Type Communication (MTC) device from an MTC service platform via a first entity in the core network; and
update, based on the mobility characteristic, at least one of (a) a length of a periodic location update timer separately applied to the MTC device and (b) a size of a paging area separately applied to the MTC device.

2. The core network node according to claim 1, wherein
the first entity is a control plane entity comprising a first signaling interface with the MTC service platform and a second signaling interface with the second entity,
the core network node is a subscriber server configured to manage subscriber information of the MTC device, and
the instructions cause the processor to update the length of the location update timer based on the mobility characteristic received from the first entity via the second signaling interface.

3. The core network node according to claim 2, wherein
the first entity comprises an MTC Interworking Function (MTC-IWF) entity, and
the core network node comprises a Home subscriber Server (HSS).

4. The core network node according to claim 1, wherein
the first entity is a control plane entity comprising a first signaling interface with the MTC service platform and a second signaling interface with a subscriber server that manages subscriber information of the MTC device,
the core network node is an entity configured to perform mobility management of the MTC device, and
the instructions cause the processor to update the size of the paging area based on the mobility characteristic received from the first entity via the subscriber server.

5. (canceled)

6. The core network node according to claim 4, wherein
the first entity comprises an MTC Interworking Function (MTC-IWF) entity, and
the core network node comprises a Mobility Management Entity (MME).

7. The core network node according to claim 1, wherein the mobility characteristic indicates a mobility level of the MTC device.

8. The core network node according to claim 1, wherein
the MTC device is a device attached to a vehicle, and
the mobility characteristic indicates whether the vehicle is travelling or whether an engine of the vehicle has been started.

9. The core network node according to claim 1, wherein
the MTC device is a device attached to freight, and
the mobility characteristic indicates whether the freight is being transported.

10. The core network node according to claim 1, wherein
the MTC device is a wearable device, and
the mobility characteristic indicates whether a person who is wearing the MTC device is away from home or at home.

11. The core network node according to claim 1, wherein
the MTC device is a device that is attached to an animal and is used to monitor the animal, and
the mobility characteristic indicates whether the animal is away from home or at home.

12. A service capability entity configured to provide a Machine Type Communication (MTC) application server, which communicates with an MTC device via a mobile communication network including a core network and a radio access network, with an application programming interface (API) to allow the MTC application server to use a service served by the mobile communication network, the service capability entity comprising:
a memory that stores instructions; and
a processor coupled to the memory and configured to execute the instructions to send, to a network entity in the core network, a first message indicating a mobility characteristic of the MTC device,
wherein the first message causes the core network to update at least one of (a) a length of a periodic location update timer separately applied to the MTC device and (b) a size of a paging area separately applied to the MTC device.

13. The service capability entity according to claim 12, wherein the mobility characteristic indicates a mobility level of the MTC device.

14. The service capability entity according to claim 12, wherein
the MTC device is a device attached to a vehicle, and
the mobility characteristic indicates whether the vehicle is travelling or whether an engine of the vehicle has been started.

15. The service capability entity according to claim 12, wherein
the MTC device is a device attached to freight, and
the mobility characteristic indicates whether the freight is being transported.

16. The service capability entity according to claim 12, wherein
the MTC device is a wearable device, and
the mobility characteristic indicates whether a person who is wearing the MTC device is away from home or at home.

17. The service capability entity according to claim 12, wherein
the MTC device is a device that is attached to an animal and is used to monitor the animal, and
the mobility characteristic indicates whether the animal is away from home or at home.

18-24. (canceled)

25. A method performed by a core network node arranged in a core network, the method comprising;
receiving a mobility characteristic of a Machine Type Communication (MTC) device from an MTC service platform via a first entity in the core network;
updating, based on the mobility characteristic, at least one of (a) a length of a periodic location update timer separately applied to the MTC device and (b) a size of a paging area separately applied to the MTC device.

26. The method according to claim 25, wherein
the first entity is a control plane entity comprising a first signaling interface with the MTC service platform and a second signaling interface with the second entity,
the core network node is a subscriber server configured to manage subscriber information of the MTC device, and
the updating comprises updating the length of the location update timer based on the mobility characteristic received from the first entity via the second signaling interface.

27. The method according to claim 25, wherein
the first entity is a control plane entity comprising a first signaling interface with the MTC service platform and a second signaling interface with a subscriber server that manages subscriber information of the MTC device,
the core network node is an entity configured to perform mobility management of the MTC device, and
the updating comprises updating the size of the paging area based on the mobility characteristic received from the first entity via the subscriber server.

28. The method according to claim 25, wherein the mobility characteristic indicates a mobility level of the MTC device.
